(19) United States
(12) Patent Application Publication
(10) Pub. No.: US 2008/0014905 A1
(43) Pub. Date: Jan. 17, 2008

(54) Authentication matching method and device

(76) Inventor: Hirobumi Suzuki, Kawasaki (JP)

Correspondence Address: BINGHAM MCCUTCHEN LLP, 2020 K Street, N.W., Intellectual Property Department, WASHINGTON, DC, 20006, US

(21) Appl. No.: 11/889,262

(22) Filed: Aug. 10, 2007

Related U.S. Application Data
(63) Continuation of application No. PCT/JP05/02423, filed on Feb. 17, 2005.

(51) Int. Cl. H04M 1/66

(52) U.S. Cl. 455/411

(57) ABSTRACT

In an authentication matching method and device which provide an optimum service to a user in view of a network condition in a state where the user is authenticated, access from the user is authenticated, an optimum network condition and service are selected, when the access is authenticated, from a database depending on a condition which the user desires to use, and the user is connected to a network connection device and a service providing device respectively corresponding to the network condition and service selected.

### CROSS-REFERENCE TO RELATED APPLICATION

This application is a continuation of International Application PCT/JP2005/002423 filed on Feb. 17, 2005, the contents of which are herein wholly incorporated by reference.

### BACKGROUND OF THE INVENTION

1. Field of the Invention

The present invention relates to an authentication matching method and device, and in particular to an authentication matching method and device which provide an optimum and safe service to a user over a network.

2. Description of the Related Art

Recently, infrastructures of Internet communication have developed in Japan, so that the number of contracts of DSL services and the number of registrations of Internet connection services by mobile phones respectively reached into 12,000,000 and 71,000,000 as of August 2004.

Not only e-mails, but also various services such as shopping, banking, auction, video distribution, and polling over the network have become available. Accordingly, frauds, unauthorized accesses, and the like have rapidly increased, and been recognized as a social problem, so that security measures for the network have become important.

As a technology of confirming access enable/disable to the network, an authentication technology at a terminal by using a password and an ID card, an authentication technology in a server system, a virus quarantine technology, and the like have been known. By using these technologies, a confirmation of an individual user and its authorization, a safe transfer of information, a securement of a safe communication path are realized between a user and a service provider.

On the other hand, in an actual service using scene, a user selects a service necessary for the user himself/herself to be used under an environment which enables the securement of safety by the access enable/disable confirmation technology. The user gives priority to a speed in some cases, and economic efficiency in other cases. For example, the user will desire to see movies with high image quality, to transmit/receive e-mails by a constant rate system even if it takes some time, and require defense services against virus, spoofing, and the like. According to a diversification of services, selecting and providing an optimum service to meet user's requirements from among services provided while a safety is secured by the access enable/disable confirmation technology become an efficient means for improving convenience.

As such an authentication matching method, a method for agency processing of negotiation about service use condition has been proposed, which is provided with a member management server which authenticates the validity of a user and a common service management server. The common service management server acquires a desired service classification indicating the classification of services, which the authorized user desires to use, and a desired benefit condition indicating a benefit condition, which the authorized user desires with respect to the desired service classification, from the authorized user through a network and presents the acquired desired benefit condition to all the specific service providers, who have been registered with respect to the trade specified by the acquired desired service classification, through a network and acquires possible conditions for provision, which indicate conditions on which specific service providers can provide services, from individual specific service providers and presents the best possible condition for provision out of these acquired possible conditions for provision to the authorized user through the network.

Patent document 1: Japanese Patent Application Laid-open No. 2002-288462

However, in the case of this patent document 1, a service which a user desires is only provided, so that there has been disadvantageous that a condition and a state (hereinafter, occasionally referred to as condition generically) of a network was not considered.

### SUMMARY OF THE INVENTION

It is accordingly an object of the present invention to provide an authentication matching method and device which provide an optimum service to a user in view of a network condition in a state where the user is authenticated.

[1] In order to achieve the above-mentioned object, an authentication matching method according to the present invention comprises: a first step of authenticating access from a user; a second step of selecting, when the access is authenticated at the first step, an optimum network condition and an optimum service from a database depending on a condition which the user desires to use; and a third step of connecting the user to a network connection device and a service providing device respectively corresponding to the network condition and the service selected at the second step.

Also, a device of the present invention which realizes the authentication matching method comprises: a first means authenticating access from a user; a second means selecting, when the access is authenticated at the first means, an optimum network condition and an optimum service from a database depending on a condition which the user desires to use; and a third means connecting the user to a network connection device and a service providing device respectively corresponding to the network condition and the service selected at the second means.

Hereinafter, the principle of the method and the device of the present invention will be described referring to FIG. 1.

FIG. 1 shows a user 1, a network 2, an authentication matching device 3, a network connection device group 4, and a service providing device group 5, which are sequentially connected as shown in FIG. 1. Also, the authentication matching device 3 is composed of an authentication device 31, a matching device 32, and a database 33 of authentication information/profile information referred to by the authentication device 31 and the matching device 32. The network connection device group 4 includes network connection devices 4_1, 4_2, 4_3, . . . , and the service providing device group 5 includes service providing devices 5_1, 5_2, 5_3, . . . . Hereinafter, the network connection device group 4 and the service providing device group 5 are occasionally referred to simply as a network connection device and a service providing device, respectively.

Firstly, when the user 1 uses a service provided on the Internet, information concerning the user 1 and the service is preliminarily registered in the authentication information/profile information database 33. As for the registration in the database 33, there are methods of registering the information through the network 2 and of directly registering the information not through the network 2, and either method may be used.

When the user 1 uses the service provided from the service providing device group 5 through the network connection device group 4, whether or not the user 1 can access the network is authenticated by using the authentication device 31. Concurrently, the matching device 32 checks if the user 1 matches with the network device group 4 or the service providing device group 5 based on the database 33, and consequently connects the user 1 to the service providing device group 5.

FIG. 2 shows an operation principle [1] on the system of FIG. 1, in which an optimum network condition (state) and an optimum service are selected depending on a condition which the user 1 desires to use (user's desirable condition), and the service is provided to the user 1.

FIG. 3 shows a flowchart of the operation principle [1]. Referring to these figures, the procedure of the operation principle [1] will now be described.

(1) When using a service provided on the Internet, the user 1 firstly accesses the authentication device 31 (at step S1 in FIG. 3) through the network 2, and enters user identification information (at step S2).

(2) The authentication device 31 compares identification information entered with information already registered in the authentication information/profile information database 33 (at steps S3 and S4). If it is false, the authentication device 31 refuses the access to the network (at step S5), while if it is true, the authentication device 31 permits the user 1 the access to the network (at step S6). It is to be noted that “network” in this case indicates not the network 2 but a network (shown by dotted lines) including the whole network connection device 4.

(3) The matching device 32 retrieves/compares information of a network condition and service information (hereinafter, occasionally referred to simply as network condition and service) in the authentication information/profile information database 33 based on a condition which the user 1 desires to use, and selects optimum information (at step S7).

(4) The network connection device 4 and the service providing device 5 respectively corresponding to the selected network condition and service are connected to the user 1 through the network 2 (at step S8).

As a result, by connecting the user 1 to the service providing device 5, the user can use an optimum service under an optimum condition.

[2] In the above-mentioned [1], the second step may include a step of selecting and presenting a plurality of candidates for the optimum network condition and the optimum service to the user, thereby enabling a selection based on a user's intention.

Also, as a device for realizing this method, in the above-mentioned [1], the second means may include a means selecting and presenting a plurality of candidates for the optimum network condition and the optimum service to the user, thereby enabling a selection based on a user's intension.

Namely, in the authentication matching method and device of the present invention, a plurality of candidates are selected for the network condition and service which seem to be optimum depending on a condition which the user desires to use, and the information thereof is presented to the user, thereby enabling a selection by the user's intention.

FIGS. 4 and 5 show an operation principle [2]. While the procedures (1) and (2) are respectively the same as those shown in FIGS. 2 and 3, subsequent procedures (3)-(5) are different.

(3) The matching device 32 retrieves/compares information of a network condition and service information (hereinafter, occasionally referred to simply as network condition and service) in the authentication information/profile information database 33 based on a condition which the user 1 desires to use (at step S9 in FIG. 5).

(4) A plurality of candidates which seem to be optimum are selected, so that the result is notified to the user 1 (at step S10).

(5) The network connection device 4 and the service providing device 5 selected by the user 1 are connected to the user (at step S11).

In this case, the selection can be performed based on the user's intention.

[3] In the above-mentioned [1], the second step may include a step of adding a condition of user (user's condition) set by the service providing device upon the selection of the network condition and the service.

Also, as a device for realizing this method, in the above-mentioned [1], the second means may include a means adding a condition of the user set by the service providing device upon the selection of the network condition and the service.

Namely, in the authentication matching method and device of the present invention, the service providing device presets a user's condition (state), selects the available service and the network condition which match with the user's condition, so that the service is provided to the user. It is to be noted that the user's condition may be preset in the authentication matching device.

FIG. 6 is a flowchart showing an operation principle [3]. The system operation principle diagram is the same as FIG. 2. Accordingly, the procedures (1), (2), and (4) are the same as those in FIGS. 2 and 3, except the following procedure (3).

(3) The matching device 32 retrieves/compares network condition information, and service information, and the condition of the user 1 set by a service provider of the service providing device 5 in the authentication information/profile information database 33, for a service which the user 1 desires to use, and selects optimum one (at step S12 in FIG. 6).

As a result, the service can be provided to the user under the conditions preferable to the service provider.

[4] In the above-mentioned [3], the second step may include a step of refusing a service provision upon having determined that the selected network condition and service are not matched with the user's condition set by the service providing device.

Also, as a device for realizing this method, in the above-mentioned [3], the second means may include a means refusing a service provision upon having determined that the selected network condition and service are not matched with the user's condition set by the service providing device.

Namely, in the authentication matching method and device of the present invention, even when the user's access to the network is authenticated, service provision enable/disable is confirmed depending on the user's condition set by the service provider. When a mismatch with the user's condition is found, the service provision is refused.

FIGS. 7 and 8 show an operation principle [4], where procedures (1)-(3) are the same as those in FIGS. 2 and 3, except the following (4).

(4) When it is found that the network condition and the service which match with the user's condition set by the service provider do not exist as a result of the retrieval/comparison of the users condition (at step S13 in FIG. 8), the service providing device 5 notifies the refusal of service provision to the user 1 (at step S14).

[5] In the above-mentioned [1], the third step may further include a step of reselecting an optimum network condition and service, when the user becomes unable to use the network connection device due to a change of the network condition while the user is connected to the network connection device and the service providing device.

Also, as a device for realizing this method, in the above-mentioned [1], the third means may further include a means reselecting an optimum network condition and service, when the user becomes unable to use the network connection device due to a change of the network condition while the user is connected to the network connection device and the service providing device.

Namely, in the authentication matching method and device of the present invention, when a service becomes unavailable due to a change of the network condition, optimum network conditions are collected again, so that the user is reconnected to a network corresponding to another network condition in which the service is available.

FIGS. 9 and 10 show an operation principle [5], where the following procedures (1)-(3) are executed.

(1) It is supposed that in FIG. 2 or 4 for example the user 1 is connected to the network connection device 4 and the service providing device 5, and is using services (at step S15 in FIG. 10).

(2) When a service becomes unavailable due to a change of a network condition while the user 1 uses the service, the matching device 32 collects optimum network conditions which can be connected to be reselected (at steps S16 and S17).

(3) The user 1 is reconnected to the network connection device 4 and the service providing device 5 corresponding to another network condition by which services are available (at step S15).

[6] In the above-mentioned [1], the third step may further include a step of reconnecting, when a superior network condition and service for the user exist while the user is connected to the network connection device and the service providing device, the user to a network connection device and a service providing device corresponding to the superior network condition and service.

Also, as a device for realizing this method, in the above-mentioned [1], the third means may further include a means reconnecting, when a superior network condition and service for the user exist while the user is connected to the network connection device and the service providing device, the user to a network connection device and a service providing device corresponding to the superior network condition and service.

Namely, in the authentication matching method and device of the present invention, when there are a network condition and a service superior to the network condition and the service the user is using, the network connection device and the service providing device to be connected are changed depending on a using state.

FIGS. 11 and 12 show an operation principle [6], where the following procedures (1)-(3) are executed.

(1) It is supposed that in FIG. 2 or 4 for example the user 1 is connected to the network connection device 4 and the service providing device 5, and is using services (at step S15 in FIG. 12).

(2) When the user 1 is using the service, the matching device 32 retrieves/compares the information of the network condition, the service information, and a user's condition set by the service provider in the authentication information/profile information database 33, and confirms the presence/absence of a network condition and a service superior to the network condition and the service presently used (at steps S18 and S19).

(3) When the superior network condition and service exist, the user 1 is reconnected to the network connection device 4 and the service providing device 5 at the end of the state presently used (at step S20).

[7] In the above-mentioned [6], the third step may further include a step of notifying, when a superior network condition and service for the user exist while the user is connected to the network connection device and the service providing device, the superior network condition and service to the user, and of reconnecting, when the user desires to be reconnected to the superior network condition and service, the user to the network connection device and the service providing device respectively corresponding thereto.

Also, as a device for realizing this method, in the above-mentioned [6], the third means may further include a means notifying, when a superior network condition and service for the user exist while the user is connected to the network connection device and the service providing device, the superior network condition and service to the user, and reconnecting, when the user desires to be reconnected to the superior network condition and service, the user to the network connection device and the service providing device respectively corresponding thereto.

Namely, in the authentication matching method and device of the present invention, when there are a network condition and a service superior to the network condition and the service the user is using, a candidate to which the network condition and the service can be changed is selected depending on a using state, so that information thereof is presented to the user.

FIGS. 13 and 14 show an operation principle [7], where the following procedures (1)-(4) are executed.

(1) It is supposed that in FIGS. 2 and 4 for example the user 1 is connected to the network connection device 4 and the service providing device 5 where the user 1 is using a service (at step S15 in FIG. 14).

(2) In the state of (1), the matching device 32 retrieves/compares the information of the network condition, the service information, and the user's condition set by the service provider in the authentication information/profile information database 33, and confirms whether or not a network condition and a service superior to the network condition and the service presently used exist (at steps S18 and S19).

(3) When the superior ones exist, whether or not the user should be reconnected to the superior network condition and service at the end of the state presently used is confirmed by notifying the result to the user 1 (at step S21).

(4) For the reconnection to the notified ones (at step S22), the user 1 is reconnected to the network connection device 4 and the service providing device 5 selected by the user 1 at the end of the state presently used (at step S20).

According to the present invention, it becomes concurrently possible to secure a security for the user, to provide an optimum service along with a condition and a service which the user desires, and to obtain the convenience to the user. Security and convenience of the Internet service are improved, so that spread and use of the service are expedited.

### BRIEF DESCRIPTION OF THE DRAWINGS

The above and other objects and advantages of the invention will be apparent upon consideration of the following detailed description, taken in conjunction with the accompanying drawings, in which the reference numerals refer to like parts throughout and in which:

FIG. 1 is a block diagram showing a principle arrangement of an authentication matching method and device according to the present invention;

FIG. 2 is a block diagram showing an operation principle [1] on the arrangement of FIG. 1 of an authentication matching method and device according to the present invention;

FIG. 3 is a flowchart showing an operation principle [1] of an authentication matching method and device according to the present invention;

FIG. 4 is a block diagram showing an operation principle [2] on the arrangement of FIG. 1 of an authentication matching method and device according to the present invention;

FIG. 5 is a flowchart showing an operation principle [2] of an authentication matching method and device according to the present invention;

FIG. 6 is a flowchart showing an operation principle [3] of an authentication matching method and device according to the present invention;

FIG. 7 is a block diagram showing an operation principle [4] on the arrangement of FIG. 1 of an authentication matching method and device according to the present invention;

FIG. 8 is a flowchart showing an operation principle [4] of an authentication matching method and device according to the present invention;

FIG. 9 is a block diagram showing an operation principle [5] on the arrangement of FIG. 1 of an authentication matching method and device according to the present invention;

FIG. 10 is a flowchart showing an operation principle [5] of an authentication matching method and device according to the present invention;

FIG. 11 is a block diagram showing an operation principle [6] on the arrangement of FIG. 1 of an authentication matching method and device according to the present invention;

FIG. 12 is a flowchart showing an operation principle [6] of an authentication matching method and device according to the present invention;

FIG. 13 is a block diagram showing an operation principle [7] on the arrangement of FIG. 1 of an authentication matching method and device according to the present invention;

FIG. 14 is a flowchart showing an operation principle [7] of an authentication matching method and device according to the present invention;

FIG. 15 is a block diagram specifically showing an embodiment of an authentication information/profile information database in a principle arrangement shown in FIG. 1;

FIG. 16 is a block diagram showing an embodiment of a network connection device and a service providing device registered in an authentication information/profile information database, used for an authentication matching method and device according to the present invention;

FIGS. 17A and 17B are block diagrams showing an operation embodiment [1] of an authentication matching method and device according to the present invention;

FIG. 18 is a flowchart showing an operation embodiment [1] of an authentication matching method and device according to the present invention;

FIG. 19 is a block diagram showing an embodiment of using a least line of an intranet in an authentication matching method and device according to the present invention;

FIG. 20 is a block diagram showing an embodiment of using a public line in an authentication matching method and device according to the present invention;

FIGS. 21A and 21B are block diagrams showing an operation embodiment [2] of an authentication matching method and device according to the present invention;

FIG. 22 is a flowchart showing an operation embodiment [2] of an authentication matching method and device according to the present invention;

FIGS. 23A and 23B are block diagrams showing an operation embodiment [3] of an authentication matching method and device according to the present invention;

FIG. 24 is a flowchart showing an operation embodiment [3] of an authentication matching method and device according to the present invention;

FIG. 25 is a block diagram showing an operation embodiment [4] of an authentication matching method and device according to the present invention;

FIG. 26 is a flowchart showing an operation embodiment [4] of an authentication matching method and device according to the present invention;

FIGS. 27A and 27B are block diagrams showing an operation embodiment [5] of an authentication matching method and device according to the present invention;

FIG. 28 is a flowchart showing an operation embodiment [5] of an authentication matching method and device according to the present invention;

FIGS. 29A and 29B are block diagrams showing an operation embodiment [6] of an authentication matching method and device according to the present invention;

FIG. 30 is a flowchart showing an operation embodiment [6] of an authentication matching method and device according to the present invention;

FIGS. 31A and 31B are block diagrams showing an operation embodiment [7] of an authentication matching method and device according to the present invention; and

FIG. 32 is a flowchart showing an operation embodiment [7] of an authentication matching method and device according to the present invention.

### DESCRIPTION OF THE EMBODIMENTS

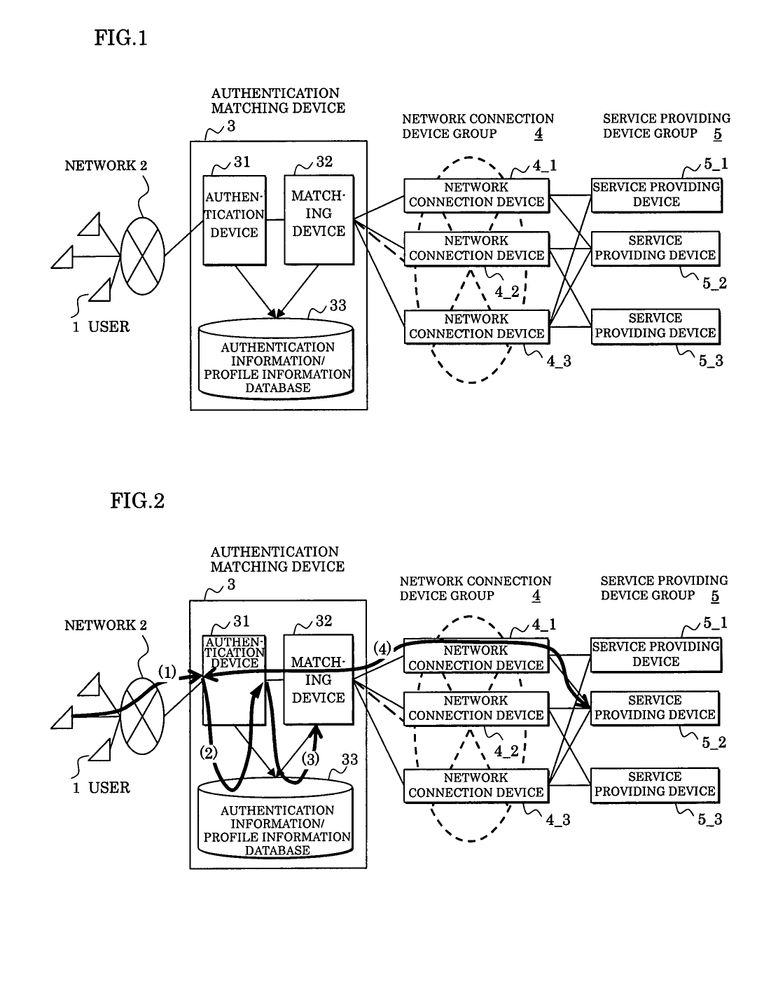

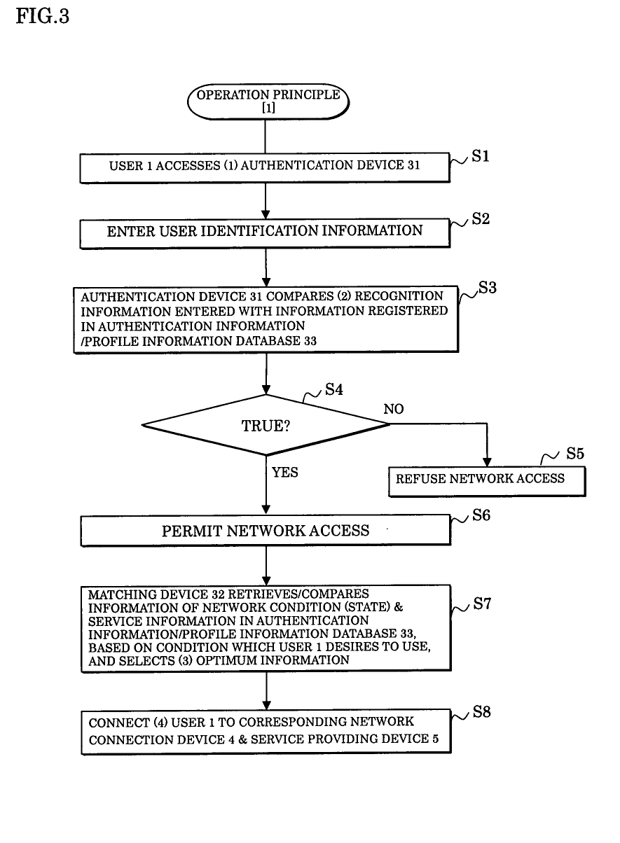

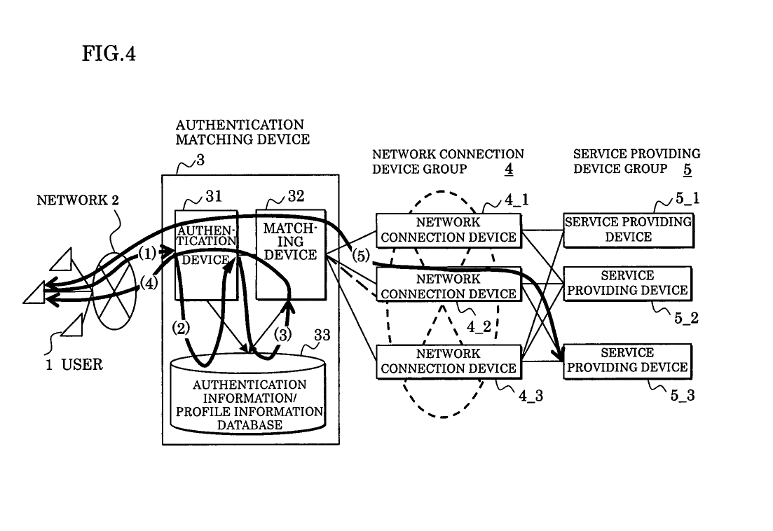

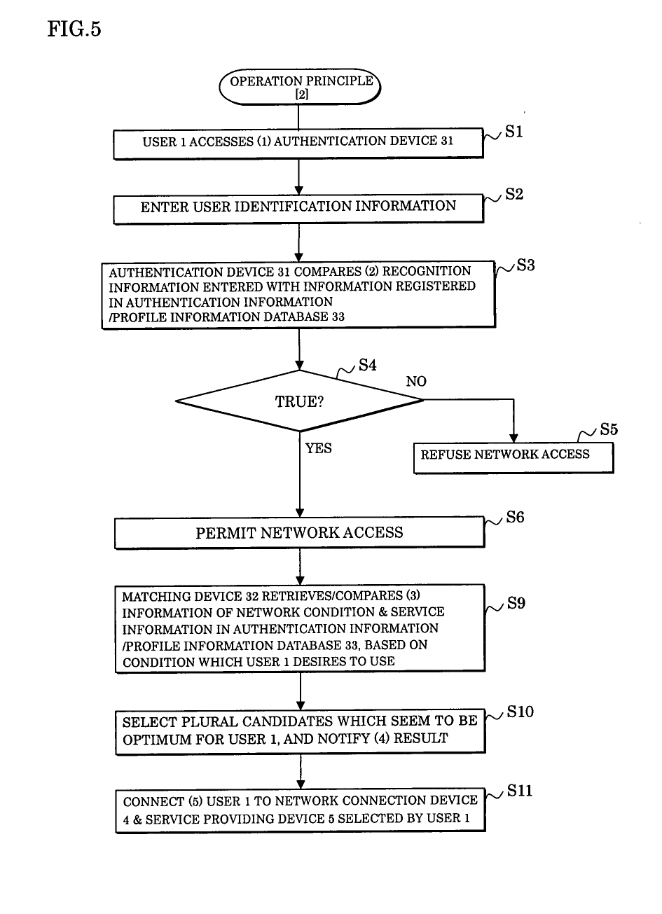

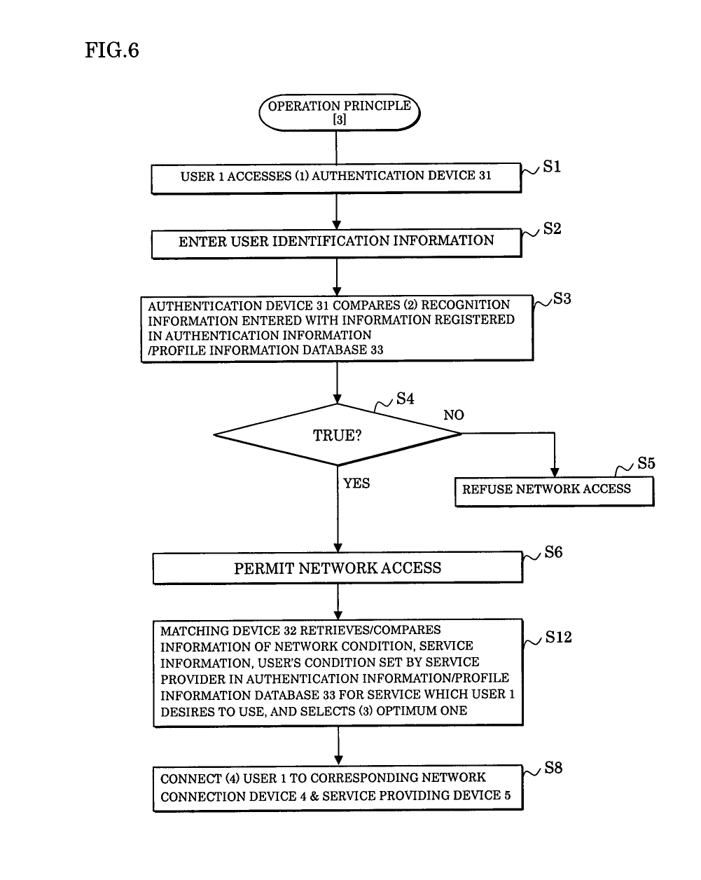

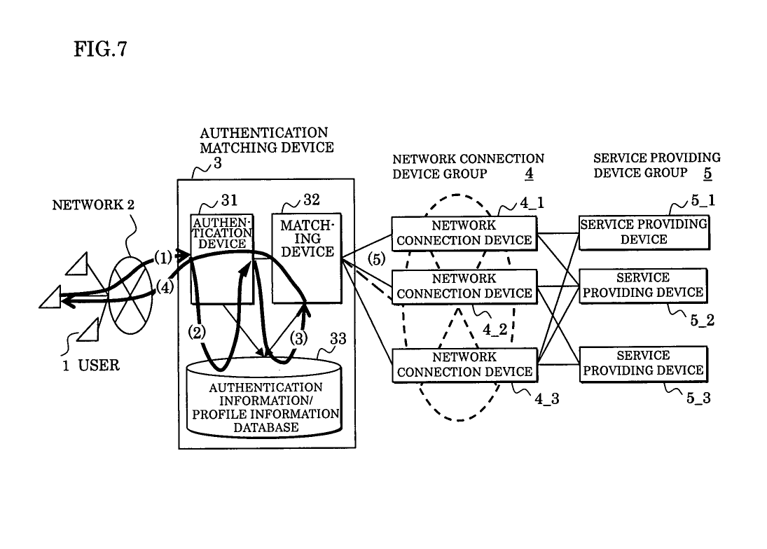

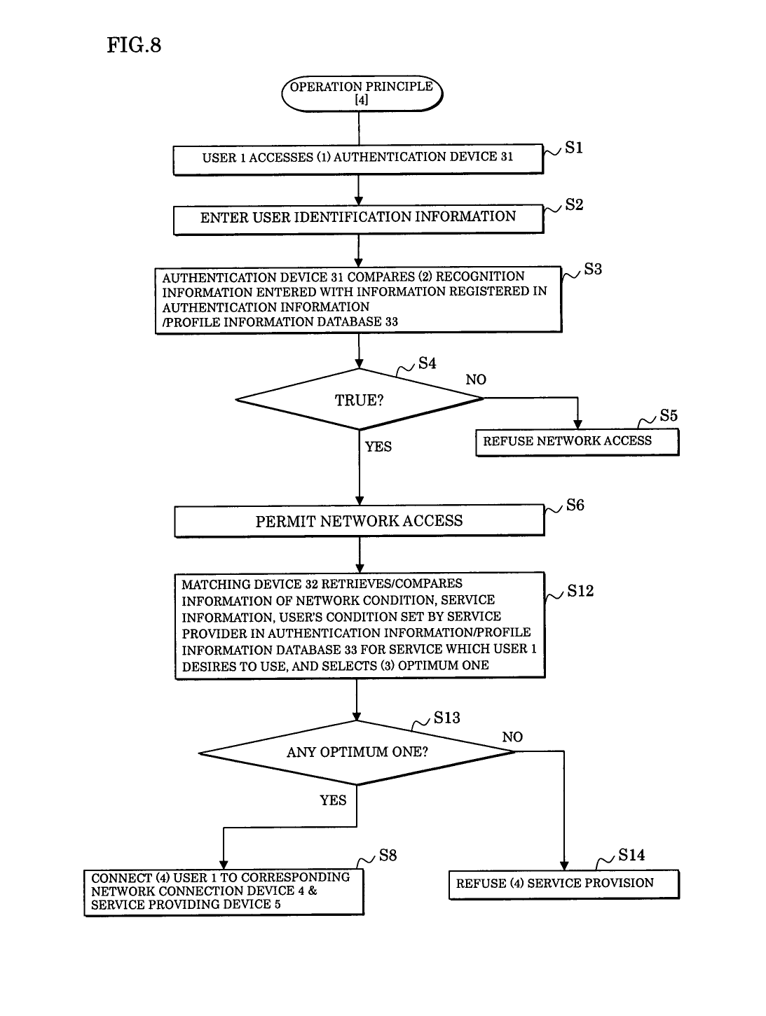

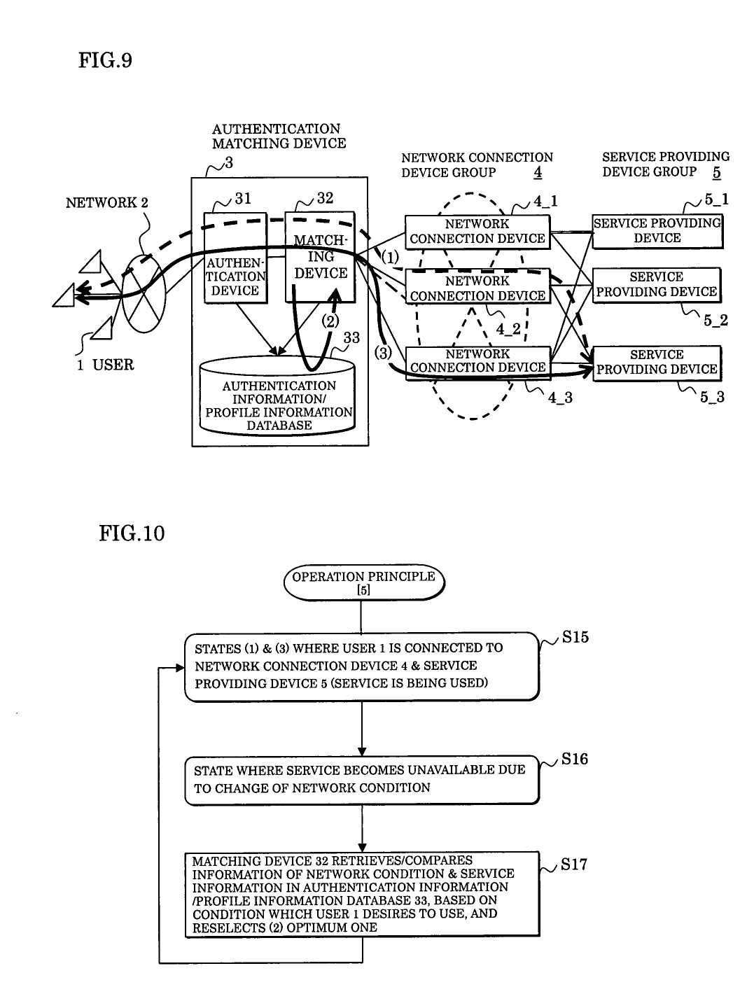

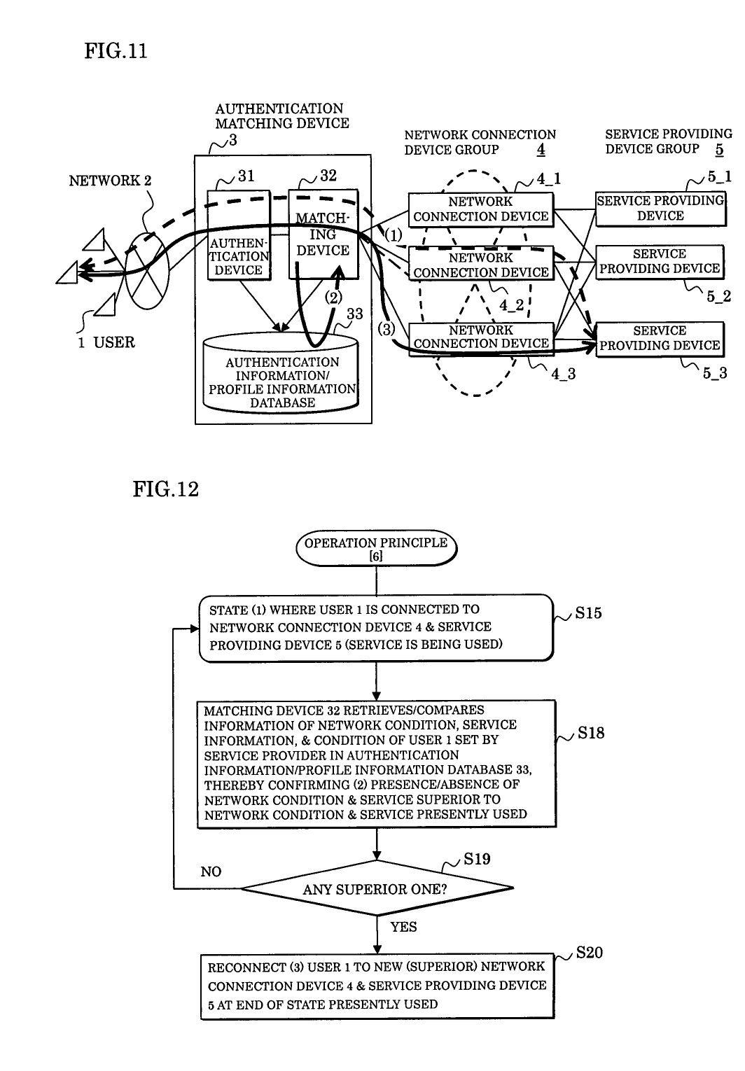

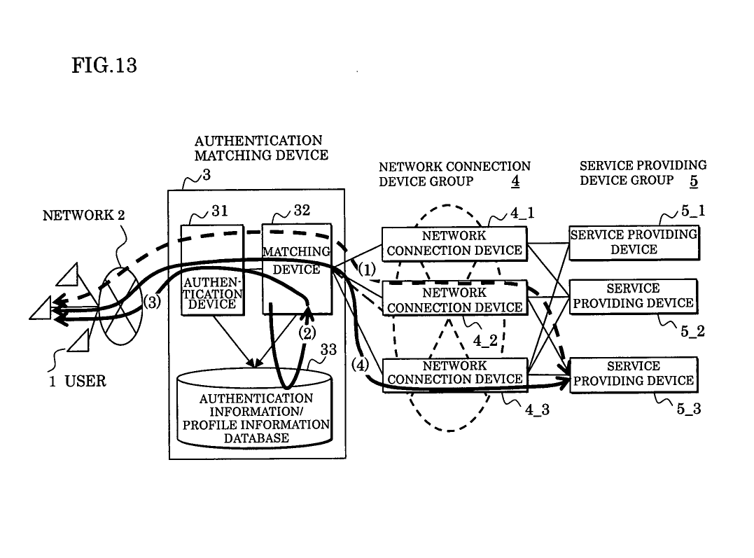

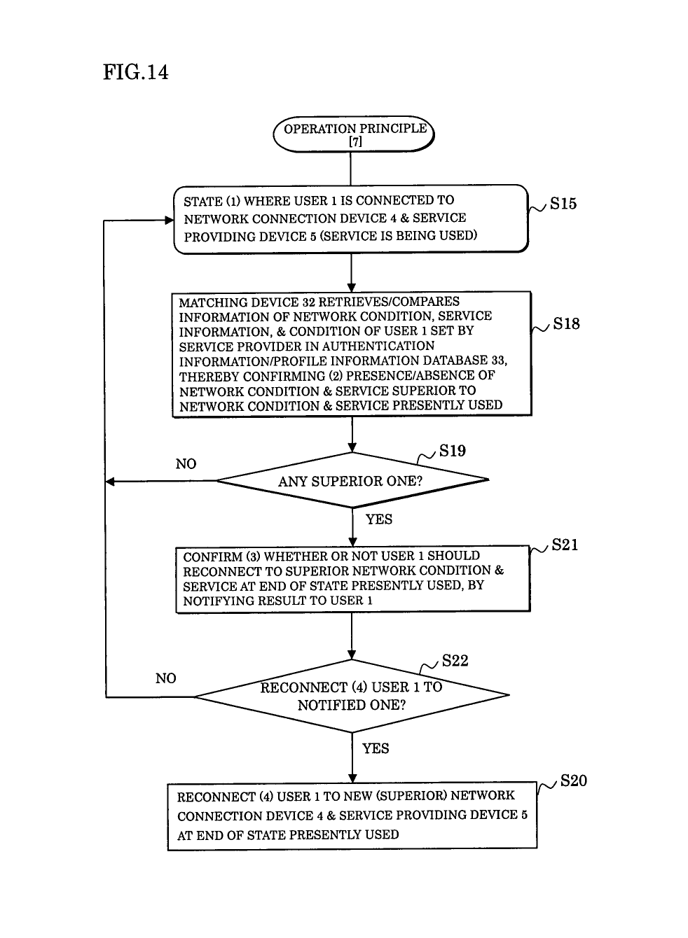

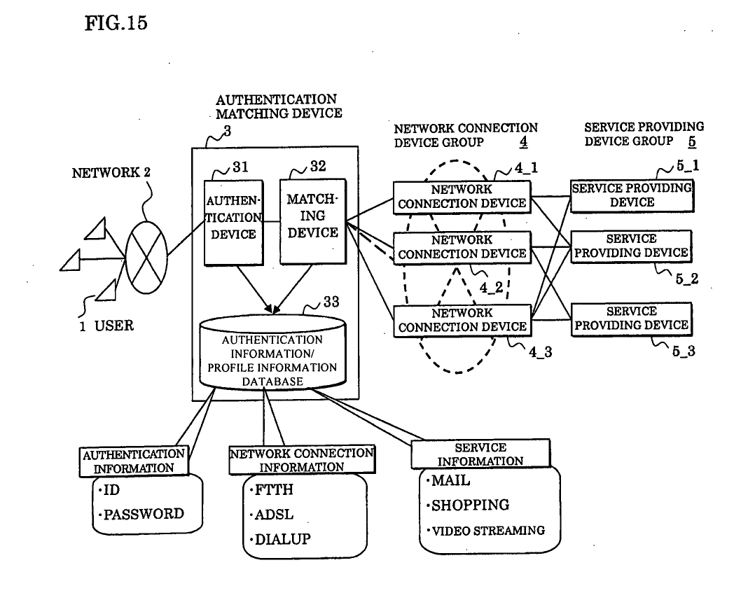

FIG. 15 shows an embodiment of the authentication information/profile information database 33 in the authentication matching device 3 shown in FIG. 1 etc.

The authentication information/profile information database 33 preliminarily registers therein information concerning the user 1 and services when the user 1 uses services provided on the Internet. As information required for authenticating the user 1, a login ID, a password, and the like are registered. Also, as information concerning the condition for connecting the network, classification information such as FTTH, ADSL, and dialup is registered. Furthermore, as information concerning services, information such as mail, shopping, and video streaming is registered.

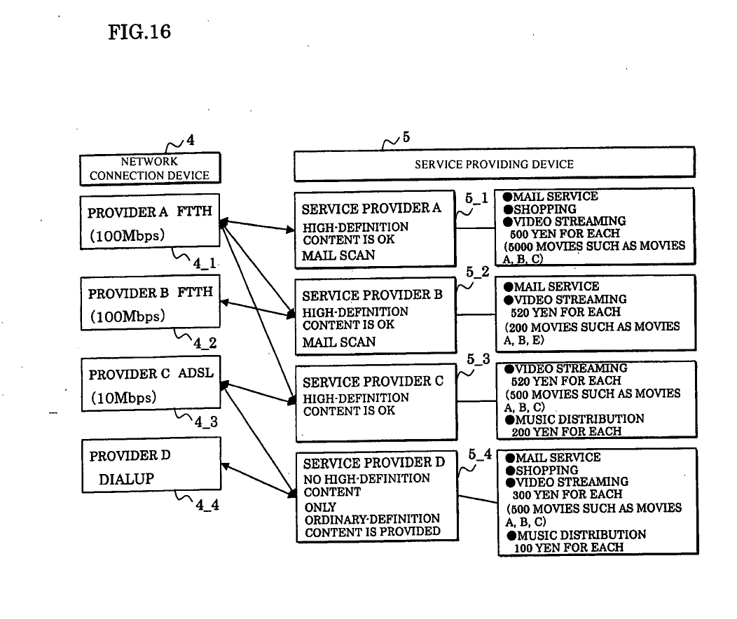

FIG. 16 shows an embodiment of the network connection device 4 and the service providing device 5 registered in the authentication information/profile information database 33. As the network connection device 4, network providers A and B (4_1 and 4_2) of FTTH (100 Mbps), a network provider C (4_3) of ADSL (10 Mbps), and a network provider D (4_4) of dialup are included. As the service providing device 5, service providers A and B (5_1 and 5_2) which allow high-definition content and provide mail scan, a service provider C (5_3) which allows high-definition content, and a service provider D (5_4) which allows only ordinary-definition content without high-definition content are included. The information mentioned above is registered in the authentication information/profile information database 33 as the profile information.

Hereinafter, various embodiments using the database 33 will be described.

### Embodiment [1]

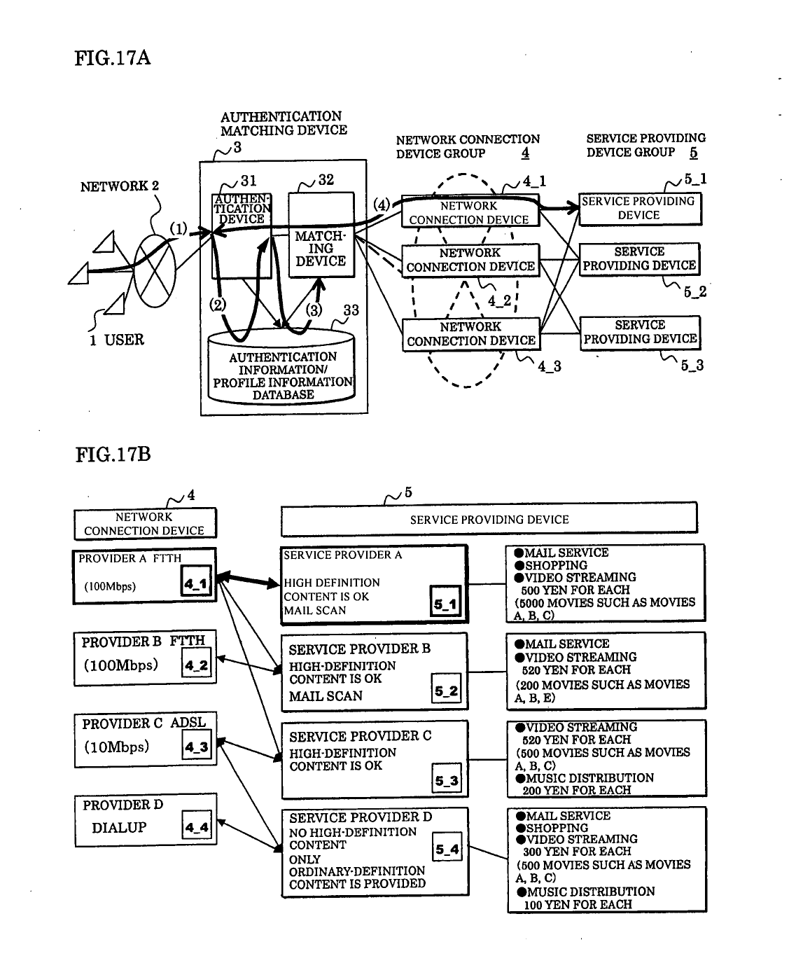

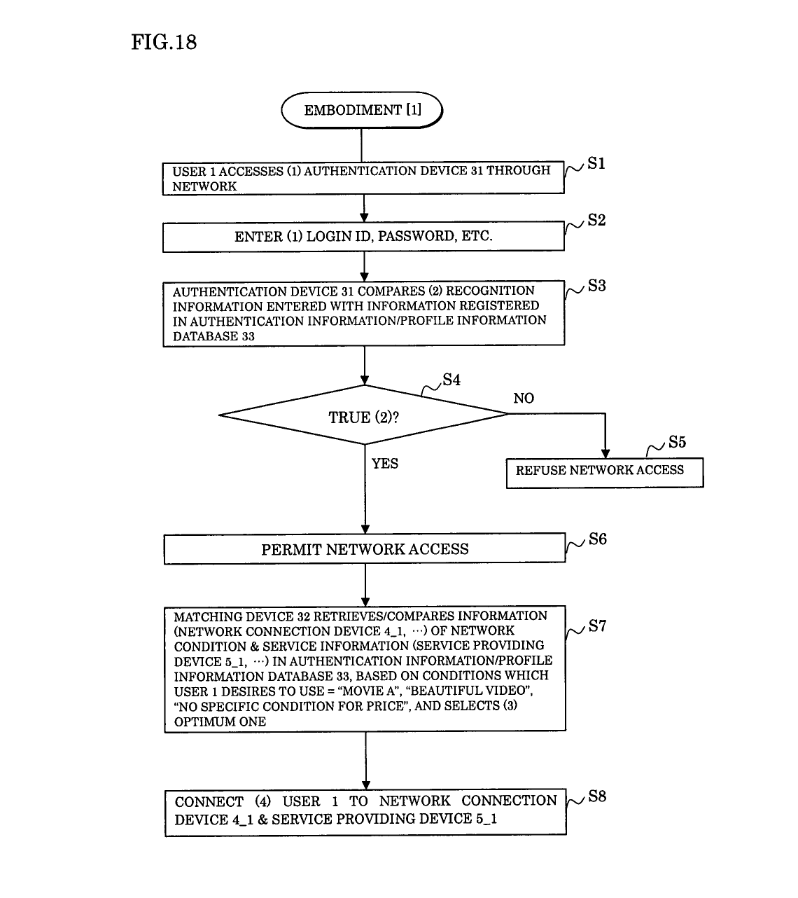

FIGS. 17A and 17B show an embodiment of a system which selects an optimum network condition and service depending on a condition which a user desires to use and provides a service to the user, which is the same as the system shown in FIG. 1 etc. The operation of this embodiment will now be described referring to the embodiment of the network connection device 4 and the service providing device 5 shown in FIG. 17B and a flowchart shown in FIG. 18.

Firstly, it is supposed that the user 1 desires to see a movie A with beautiful video (picture) by using the Internet. When the user 1 uses services, the following procedure is executed:

(1) The user 1 accesses the authentication device 31 through the network 2, and enters a login ID, a password, and the like as the user identification information (at steps S1 and S2 in FIG. 18).

(2) The authentication device 31 compares the recognition information entered with the information already registered in the authentication information/profile information database 33. If it is true, the authentication device 31 permits the user 1 to access the network (at steps S3, S4, and S6), while if it is not true, the access to the network is denied (at step S5).

(3) The matching device 32 retrieves/compares the information of the network condition (state) and the service information in the authentication information/profile information database 33 based on the condition which the user 1 desires to use. In this case, the user 1 retrieves the service providing devices 5_1, 5_2, and 5_3 which can deliver the “movie A” and the high-definition content from “movie A”, “beautiful video”, and “no specific condition for price”, compares the service providing devices 5_1, 5_2, and 5_3 with each other, and selects the FTTH network connection device 4_1 of the network provider A and the high-definition content service providing device 5_1 of the content service provider B which are thought to be optimum for the user 1, which is of 100 Mbps and inexpensive generally (at step S7).

(4) The user 1 is connected to the network connection device 4_1 and the service providing device 5_1 (at step S8).

As a result, as shown in hatching in FIG. 17B, the user 1 and the service providing device 5_1 are connected through the network connection device 4_1, thereby enabling the user 1 to see the movie A with beautiful video.

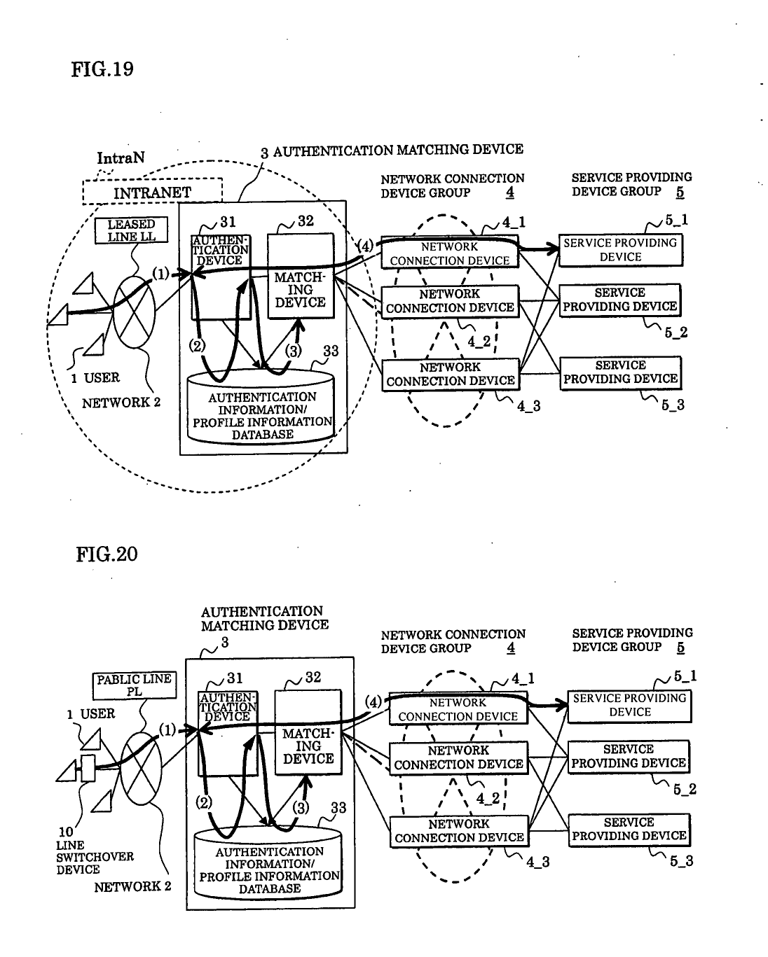

Based on FIGS. 17A and 17B, the connection examples of the user 1, the authentication device 31, the matching device 32, and the authentication information/profile information database 33 are illustrated in FIGS. 19 and 20.

In FIG. 19, it is supposed that the user 1 uses a terminal connected to an intranet. The user 1, the authentication device 31, the matching device 32, and the authentication information/profile information database 33 are connected to an intranet IntraN.

The user 1 accesses the authentication device 31 by using a leased line LL in the office from a PC terminal on the desk. When the access to the network 2 is permitted by the authentication device 31, the matching device 32 subsequently retrieves/compares the information in the authentication information/profile information database 33, resultantly selecting the high-definition content service providing device 5_1 of the content service provider B through the network connection device 4_1 of the network provider A by the above-mentioned example.

The matching device 32 gives instructions of connecting the path between the user 1, the network provider A, and the content service provider B. Thus, as shown by hatching, the user 1 can use services of the high-definition content service providing device 5_1 of content service provider B through the network connection device 4_1.

In FIG. 20, it is supposed that the user 1 uses services with a public line PL through a line switching device 10 from a PC terminal at home. The authentication device 31, the matching device 32, and the authentication information/profile information database 33 which form connecting destinations are connected within a local network 2.

The user 1 accesses the authentication device 31 by using the public line PL from the PC at home. In the same way as the case of FIG. 19, when the access to the network is permitted by the authentication device 31, the matching device 32 subsequently retrieves/compares the information of the authentication information/profile information database 33, resultantly selecting the high-definition content service providing device 5_1 of the content service provider B through the network connection device 4_1 of the network provider A.

The matching device 32 gives instructions of connecting the path between the user 1, the network provider A, and the content service provider B. At this time, the user 1 connects to the network connection device 4_1 of the network provider A by using a gateway device by which a line can be switched depending on a network attribute (dialup, ADSL, FTTH, or the like) of the line connected, connects to the content service providing device 5_1 through the network connection device 4_1, and can use the service of the high-definition content service providing device 5_1 of the content service provider B.

### Embodiment [2]

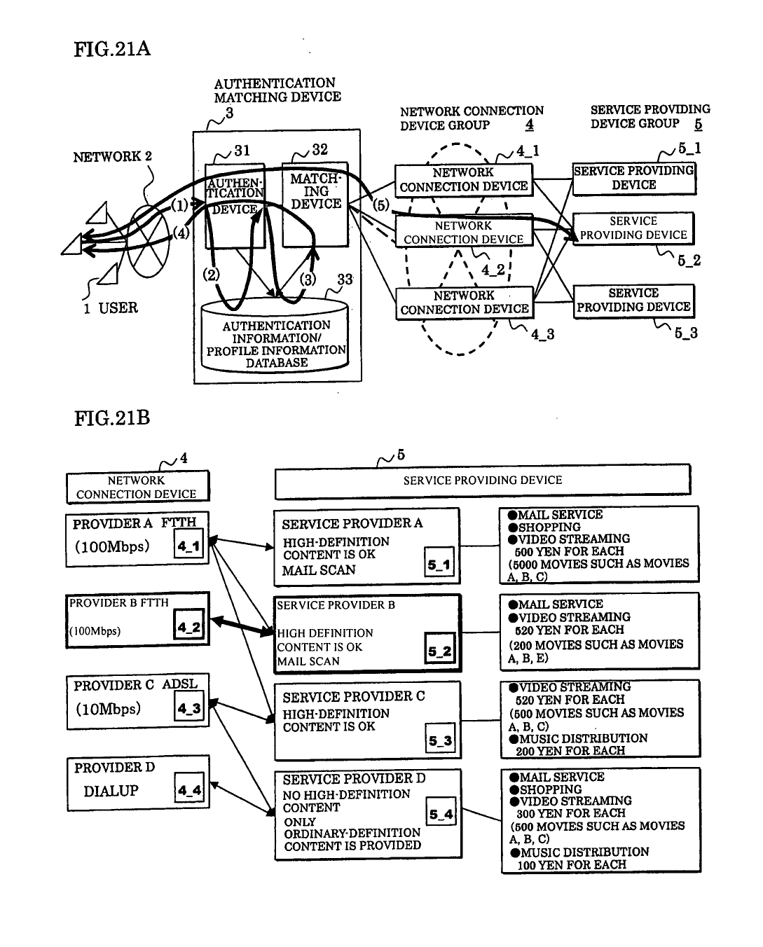

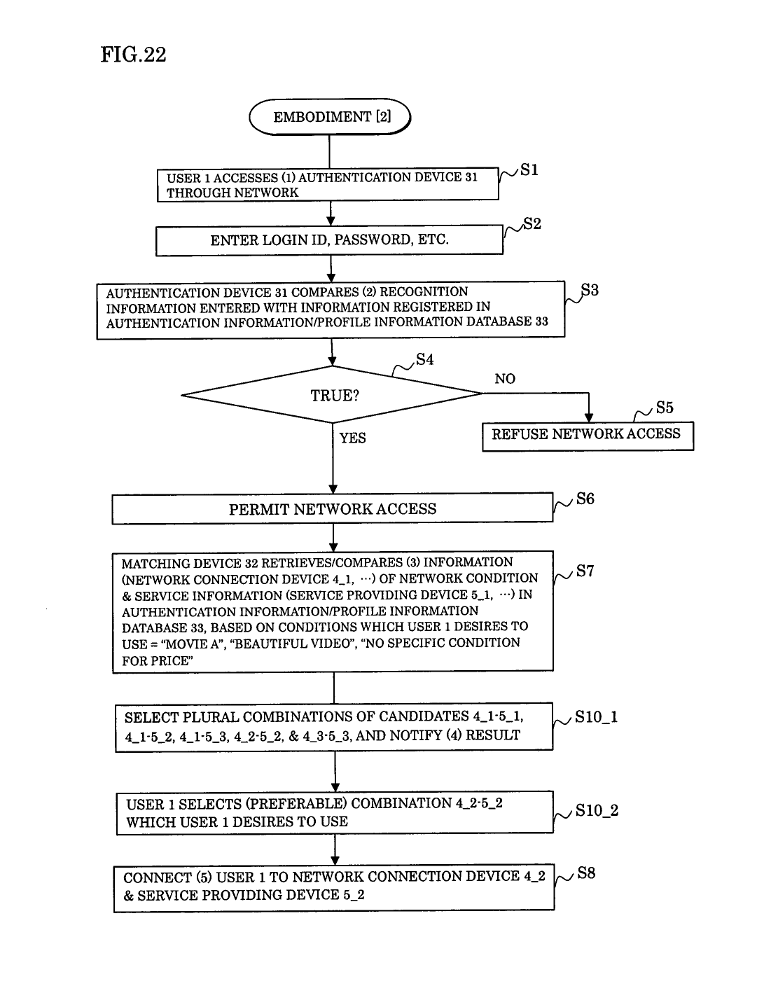

FIGS. 21A and 21B show an embodiment [2] in which some candidates are selected from among the network conditions and services selected depending on a condition which the user desires to use, the information thereof is presented to the user, and a condition and a service are selected based on the user's intention. The procedure thereof will now be described referring to the flowchart of FIG. 22.

(1) The user 1 accesses the authentication device 31 through the network 2, and enters the login ID, the password, and the like as the user identification information (at steps S1 and S2 in FIG. 22).

(2) The authentication device 31 permits the user 1 to access the network (at steps S3, S4, and S6).

(3) The matching device 32 retrieves/compares the information of the network condition and service information in the authentication information/profile information database 33 based on the condition which the user 1 desires to use (at step S7).

(4) When “movie A”, “beautiful video”, and “no specific condition for price” are selected as the conditions which the user 1 desires to use, the following result is notified to the user 1 (at step S10_1):

The FTTH network connection device 4_1 of the network provider A and the high-definition content service providing device 5_1 of the content service provider A;
The FTTH network connection device 4_1 of the network provider A and the high-definition content service providing device 5_2 of the content service provider B;
The FTTH network connection device 4_1 of the network provider A and the high-definition content service providing device 5_3 of the content service provider C;
The FTTH network connection device 4_2 of the network provider B and the high-definition content service providing device 5_2 of the content service provider B; and
The ADSL network connection device 4_3 of the network provider C and the high-definition content service providing device 5_3 of the content service provider C.

In response, when the user 1 collects service coupons of the network B provider and desires to use the provider B, the following devices are selected:
FTTH network connection device 4_2 of the network provider B and the high-definition content service providing device 5_2 of the content service provider B (at step S10_2).
   (5) As a result, as shown in FIGS. 21A and 21B, the user 1 is connected to the network connection device 4_2 and the service providing device 5_2 (at step S8), thereby enabling the user 1 to see the movie A with beautiful video by using the network provider B.

### Embodiment [3]

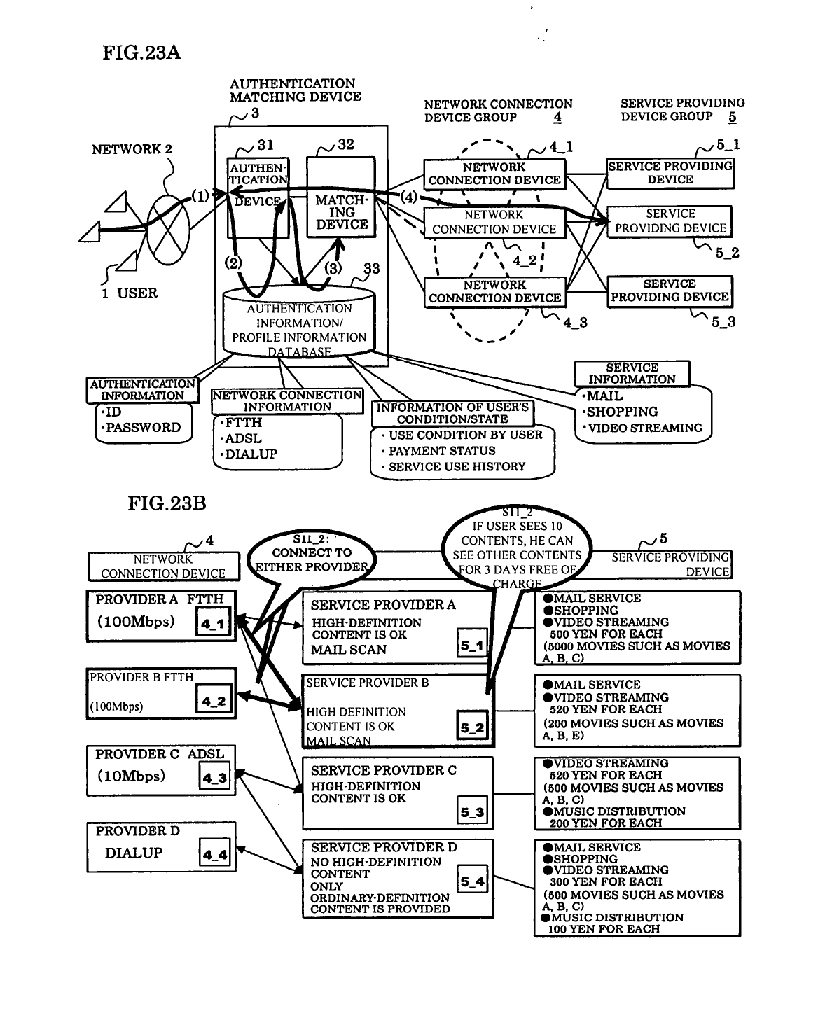

FIGS. 23A and 23B show an embodiment [3] in which the service provider confirms the condition of the user, selects the available condition of the network and service, and provides the service to the user.

Firstly, it is supposed that the user 1 desires to see the movie A with beautiful video by using the Internet. In the authentication information/profile information database 33, information such as login ID, and password required for authenticating the user 1, information such as mail, shopping, video streaming, and a service type such as FTTH, ADSL, and dialup for connecting the network is preliminarily registered.

The procedure up to now is the same as that of the embodiment, etc in FIGS. 17A and 17B. However, in this embodiment, information concerning a user's condition such as a use condition by a user, user's payment status, and a service use history is stored as the condition/state of the user set by the service provider.

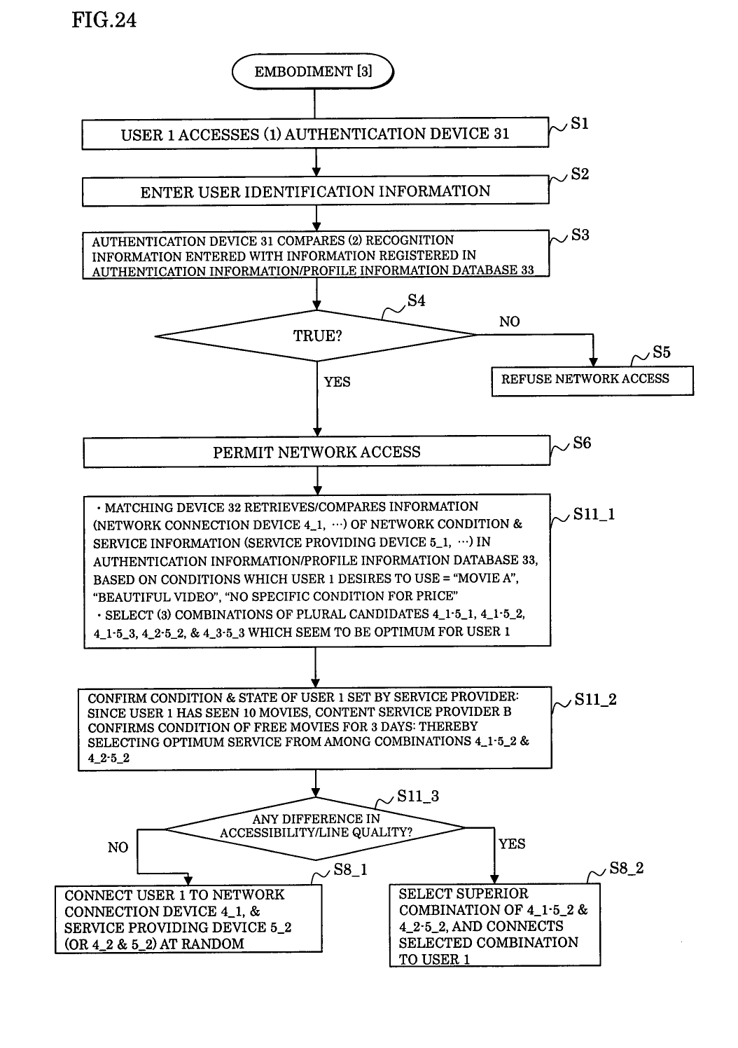

The procedure will now be described referring to the flowchart in FIG. 24.

(1) The user 1 accesses the authentication device 31, and enters the user identification information (at steps S1 and S2 in FIG. 24).

(2) The authentication device 31 compares the entered recognition information with the information already registered in the authentication information/profile information database 33. It is supposed that the recognition information is determined to be true and the access to the network is permitted (at steps S3, S4, and S6).

(3) The matching device 32 retrieves/compares the information of the network condition and the service information in the authentication information/profile information database 33 based on the condition which the user 1 desires to use. When “movie A”, “beautiful video”, and “no specific condition for price” are selected as conditions of the user 1, the matching device 32 selects (at step S11_1) the following combinations from the result of the retrieval/comparison:
The FTTH network connection device 4_1 of the network provider A and the high-definition content service providing device 5_1 of the content service provider A;
The FTTH network connection device 4_1 of the network provider A and the high-definition content service providing device 5_2 of the content service provider B;
The FTTH network connection device 4_1 of the network provider A and the high-definition content service providing device 5_3 of the content service provider C;
The FTTH network connection device 4_2 of the network provider B and the high-definition content service providing device 5_2 of the content service provider B; and
The ADSL network connection device 4_3 of the network provider C and the high-definition content service providing device 5_3 of the content service provider C.

It is supposed that as the user's condition, the content service provider B provides free contents for three days from the next day when the user sees ten contents. When the user 1 has already finished seeing ten other movies from the content service provider, the optimum service provider for the user 1 at this time is the content service provider B. As a result, any one of the following combinations with the equivalent condition is extracted at random (at step S11_2):
The FTTH network connection device 4_1 of the network provider A and the high-definition content service providing device 5_2 of the content service provider A; and
The FTTH network connection device 4_2 of the network provider B and the high-definition content service providing device 5_2 of the content service provider B.

This is indicated by thick lines in FIGS. 23A and 23B.

(4) If there is a difference of superiority in the accessibility (probability of accessibility) and line quality (shake of image or the like) during the service between the FTTH network connection device 4_1 of the network provider A and the content service provider A, and the FTTH network connection device 4_2 of the network provider B and the content service provider B, in terms of network condition (state), the matching device 32 selects a superior combination to be connected (at steps S11_3, S8_1, and S8_2).

### Embodiment [4]

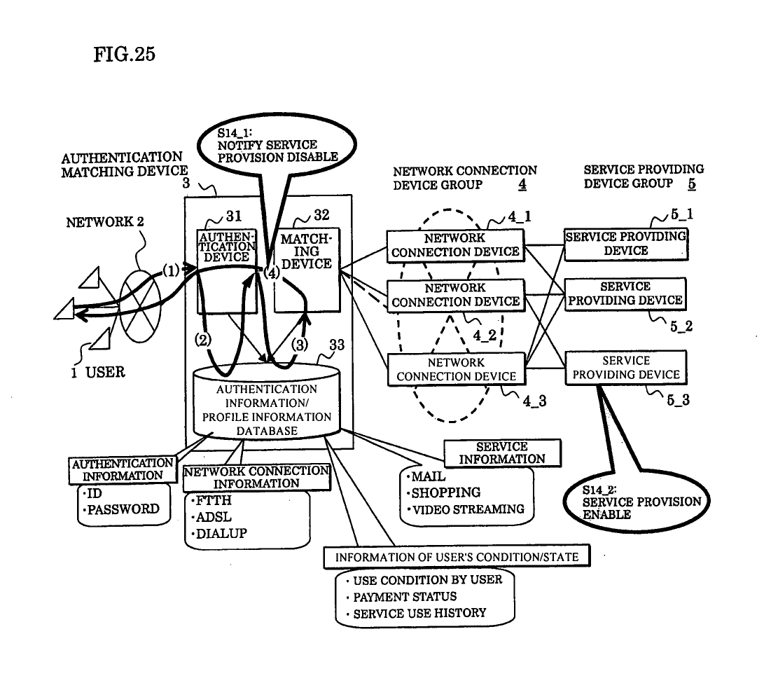

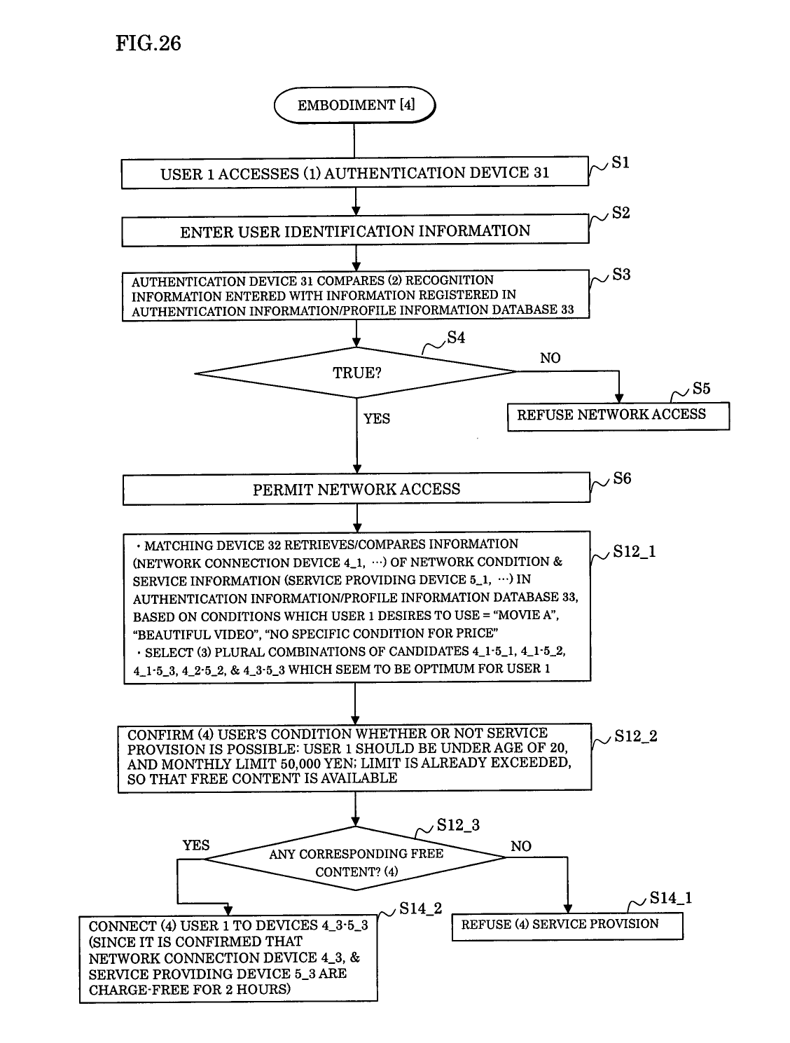

FIG. 25 shows an embodiment [4] in which even when the user is authenticated to be able to access the network, the service provider confirms service provision enable/disable depending on the user's condition. The procedure thereof will now be described referring to the flowchart in FIG. 26.

(1) The user 1 accesses the authentication device 31 and enters the user identification information (at steps S1 and S2 in FIG. 26).

(2) The authentication device 31 permits the user 1 to access the network (at steps S3, S4, and S6).

(3) The matching device 32 retrieves/compares the information of the network condition and the service information in the authentication information/profile information database 33 based on the condition which the user 1 desires to use. When “movie A”, “beautiful video”, and “no specific condition for price” are selected as the condition of the user 1, the matching device 32 firstly selects (at step S12_1) the following combinations as candidates from the result of the retrieval/comparison in the same way as the case of FIGS. 23A and 23B:
The FTTH network connection device 4_1 of the network provider A and the high-definition content service providing device 5_1 of the content service provider A;
The FTTH network connection device 4_1 of the network provider A and the high-definition content service providing device 5_2 of the content service provider B;
The FTTH network connection device 4_1 of the network provider A and the high-definition content service providing device 5_3 of the content service provider C;
The FTTH network connection device 4_2 of the network provider B and the high-definition content service providing device 5_2 of the content service provider B; and
The ADSL network connection device 4_3 of the network provider C and the high-definition content service providing device 5_3 of the content service provider C.
   (4) As the use condition of the user 1, a monthly limit for a general user under the age of 20 is set to 50,000 yen, common to the network providers and the content service providers, and only free content service can be available after the user goes beyond the monthly limit (at step S12_2). When the user has already gone beyond the monthly limit, and if there is no free content, the matching device 32 notifies service unavailability to the user 1 (at steps S12_3 and S14_1).

In this case, supposing that e.g. the high-definition content service providing device 5_3 of the service provider C provides a service such as “free content service up to two hours in the same day”, the matching device 32 confirms whether or not the movie A is less than 2 hours, instead of notifying the service unavailability. If it is the case, the use condition by the user can be cleared, and the following combination is selected:
The ADSL network connection device 4_3 of the network provider C and the high-definition content service providing device 5_3 of the content service provider C.

Therefore, the user 1 is connected to the high-definition content service providing device 5_3 (at steps S12_3 and S14_2).

### Embodiment [5]

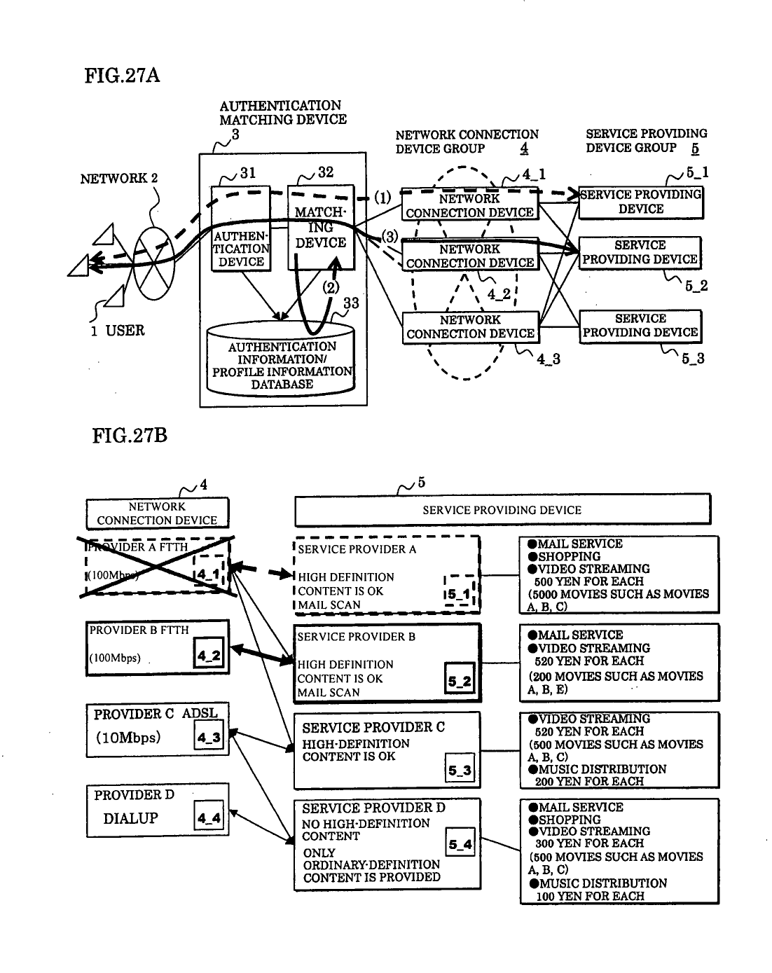

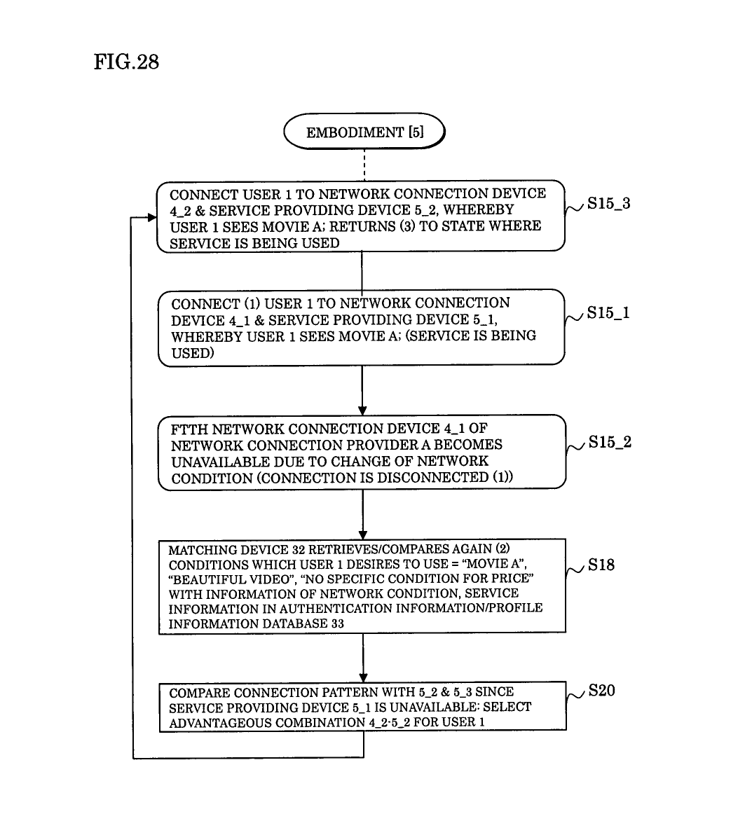

FIGS. 27A and 27B show an embodiment [5] in which when the service becomes unavailable due to the change of the network condition, an optimum network condition is collected again, and the user is reconnected to a network corresponding to another network condition with which the service is available. Hereinafter, the procedure thereof will be described referring to the flowchart in FIG. 28.

(1) Firstly, it is supposed that the user 1 is connected to the network connection device 4_1 and the service providing device 5_1 by the above-mentioned method and the user 1 sees the movie A (at step S15_1 in FIG. 28).

It is supposed that the FTTH network connection device 4_1 of the network provider A becomes unavailable. At this time, the connection between the user 1, the network connection device 4_1, and service providing device 5_1 is released.

(2) The matching device 32 retrieves/compares again an optimum network condition connectable under the condition of “movie A”, “beautiful video”, and “no specific condition for price” (at step S18).

In order to see the movie A as the high-definition content, the service providing devices 5_1, 5_2, and 5_3 within the service providing device 5 in FIGS. 27A and 27B are selected/compared, so that the device which is thought to be optimum for the user is selected.

As a result, the FTTH network connection device 4_1 of the network provider A and the high-definition content service providing device 5_1 of the content service provider B are selected and connected, since 100 Mbps is generally superior to 10 Mbps and the cheaper one is optimum for the user. However, since the service providing device 5_1 becomes unavailable, the service providing device 5_2 and the service providing device 5_3 are compared. Also in this case, since 100 Mbps is generally superior to 10 Mbps, the FTTH network connection device 4_2 for the network provider B and the high-definition content service providing device 5_2 of the content service provider B are selected (at step S20).

This is indicated in FIGS. 27A and 27B. In the above-mentioned procedure (1), as shown by the dotted lines, the network connection device 4_1 and the service providing device 5_1 are selected. However, it is found that by the procedure (3), the network connection device 4_2 and the service providing device 5_2 are newly selected and connected to the user 1.

(3) As a result, the user 1 is connected to the service providing device 5_2, thereby enabling the user to see the movie A again (at step S15_3).

### Embodiment [6]

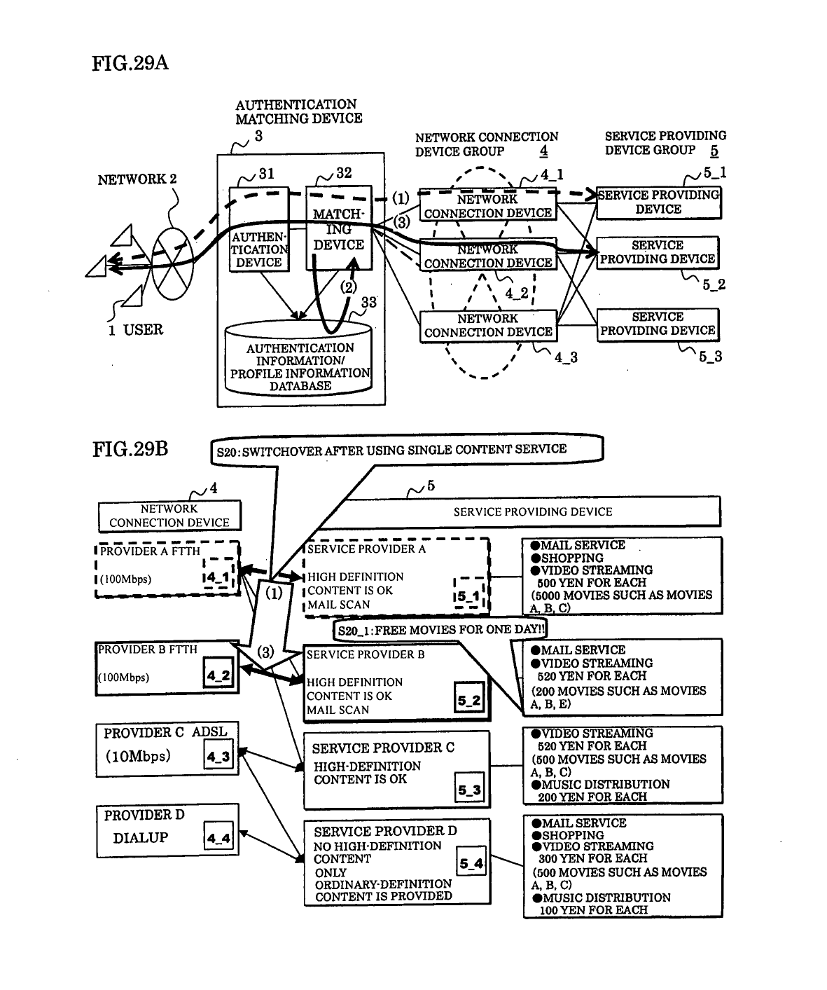

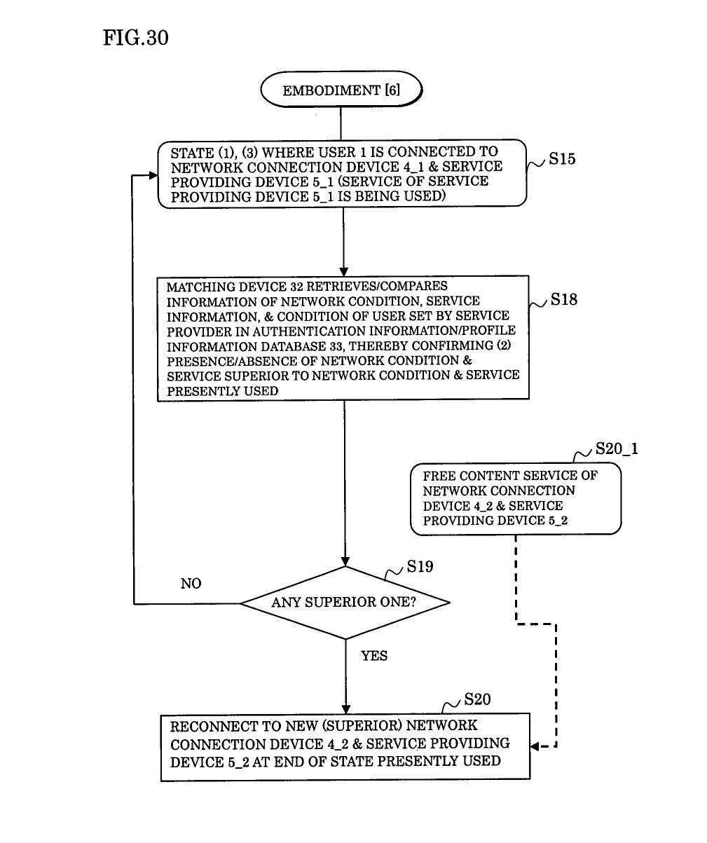

FIGS. 29A and 29B show an embodiment [6] in which when there are a network condition and a service superior to the network condition and the service the user is presently using, the network condition and the service to be connected are changed depending on the state of usage. Hereinafter, the procedure thereof will be described referring to the flowchart in FIG. 30.

(1) It is supposed that the user 1 is connected to the network connection device 4_1 and the service providing device 5_1 by the above-mentioned method and the user 1 is using the service of the service providing device 5_1 (at step S15 in FIG. 30).

(2) In this case, it is confirmed whether or not a condition and a service superior to the condition and the service presently used exist (at steps S18 and S19). Namely, it is supposed that when the FTTH network connection device 4_2 of the network provider B accesses the high-definition content service providing device 5_2 of the content service provider B, a service of free movie for one day is performed. By changing the condition, the optimum network condition for the user 1 changes to the following combination (at step S20_1):
FTTH network connection device 4_2 of the network provider B and the high-definition content service providing device 5_2 of the content service provider B.
   (3) By using the service providing device 5_1, the matching device 32 changes the connection to the following combination at the end of the content presently used:
FTTH network connection device 4_2 of the network provider B and the high-definition content service providing device 5_2 of the content service provider B (at step S20).

This state is shown in FIGS. 29A and 29B. As a result, the connection change is performed from the procedure (1) shown by the dotted lines to the procedure (3) shown by the solid lines in the same way as the embodiment [5]. Thus, more preferable service for the user 1 can be available.

### Embodiment [7]

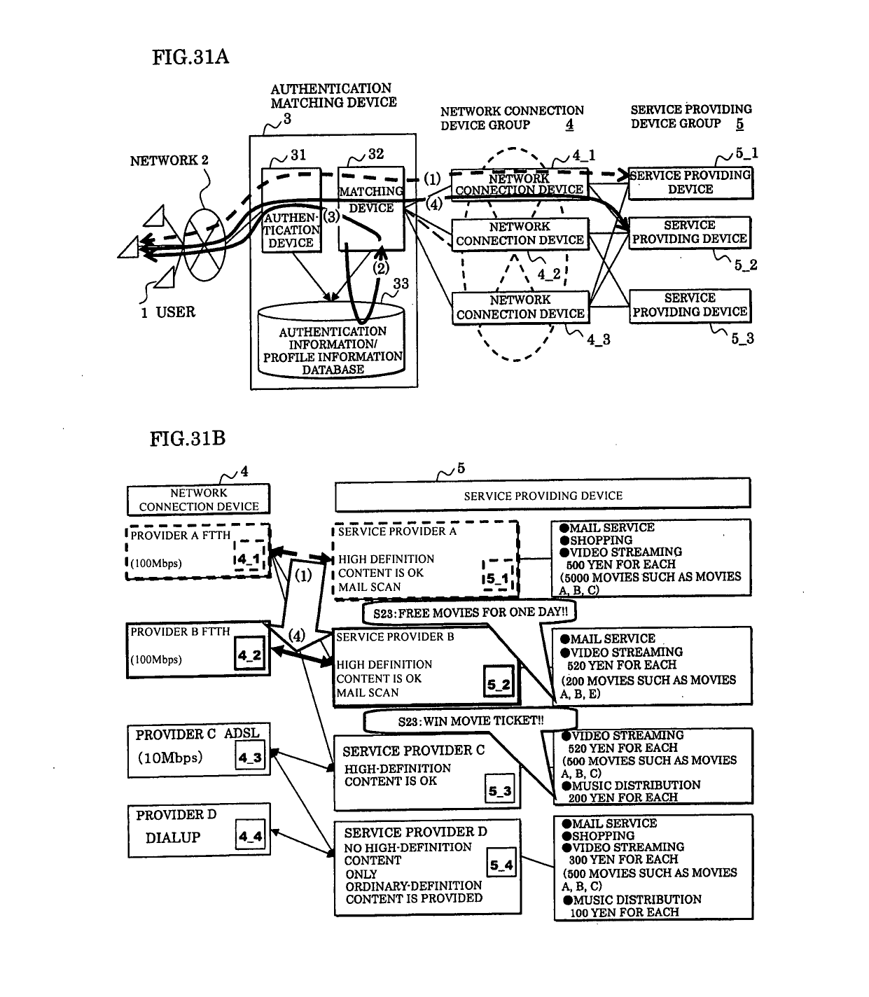

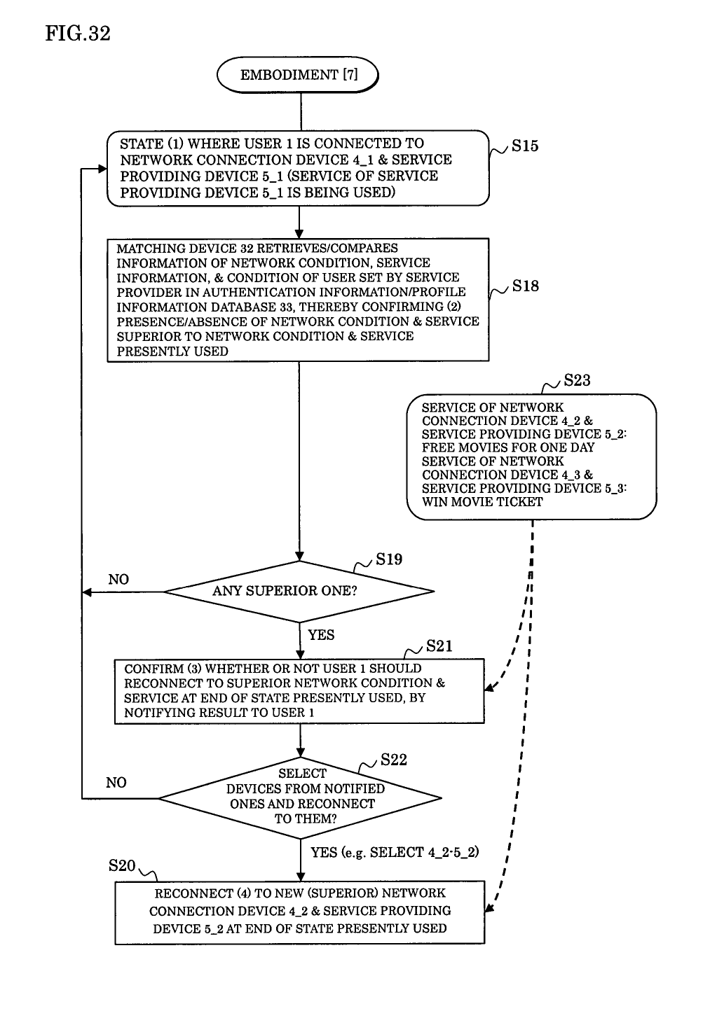

FIGS. 31A and 31B show an embodiment [7] in which when there are a network condition and a service superior to the network condition and the service the user is presently using, candidates which can be changed are selected depending on the state of usage, and the information thereof is presented to the user. Hereinafter, the procedure thereof will be described referring to the flowchart in FIG. 32.

(1) It is supposed that the user 1 is connected to the network connection device 4_1 and the service providing device 5_1 by the above-mentioned method, using the service of the service providing device 5_1 (at step S15 in FIG. 32).

(2) In this case, whether or not there are a network condition and a service superior to the network condition and the service the user is presently using is confirmed (at steps S18 and S19).

Namely, the network condition and the service for the user 1 may change as follows (at step S23):
when the FTTH network connection device 4_2 of the network provider B accesses the high-definition content service providing device 5_2 of the content service provider B, movies can be seen free of charge for one day;
when the ADSL network connection device 4_3 of the network provider C accesses the high-definition content service providing device 5_3 of the content service provider C, a user can win a movie ticket.

Then, it is supposed that the matching device 32 can determine that the followings become superior:
from the FTTH network connection device 4_2 of the network provider B to the high-definition content service providing device 5_2 of the content service provider B;
from the ADSL network connection device 4_3 of the network provider C to the high-definition content service providing device 5_3 of the content service provider C.
   (3) The matching device 32 notifies the result to the user 1, so that it is confirmed whether or not the connection is changed at the service end of the content presently used (at steps S21 and S22).
   (4) As a result, when the user 1 desires to change the connection from the FTTH network connection device 4_2 of the network provider B to the high-definition content service providing device 5_2 of the content service provider B, the connection is changed at the end of the service presently used (at step S20).

Thus, as shown in FIGS. 31A and 31B, the connection is changed from the network connection device 4_1 and the service providing device 5_1 selected/connected by the procedure (1) to the network connection device 4_2 and the service providing device 5_2 selected by the procedure (4), thereby enabling an appropriate and more advantageous service for the user 1 to be used.

What is claimed is:

1. An authentication matching method comprising:
a first step of authenticating access from a user;
a second step of selecting, when the access is authenticated at the first step, an optimum network condition and an optimum service from a database depending on a condition which the user desires to use; and
a third step of connecting the user to a network connection device and a service providing device respectively corresponding to the network condition and the service selected at the second step.

2. The authentication matching method as claimed in claim 1, wherein the second step includes a step of selecting and presenting a plurality of candidates for the optimum network condition and the optimum service to the user, thereby enabling a selection based on a user's intention.

3. The authentication matching method as claimed in claim 1, wherein the second step includes a step of adding a condition of the user set by the service providing device upon the selection of the network condition and the service.

4. The authentication matching method as claimed in claim 3, wherein the second step includes a step of refusing a service provision upon having determined that the selected network condition and service are not matched with the user's condition set by the service providing device.

5. The authentication matching method as claimed in claim 1, wherein the third step further includes a step of reselecting an optimum network condition and service, when the user becomes unable to use the network connection device due to a change of the network condition while the user is connected to the network connection device and the service providing device.

6. The authentication matching method as claimed in claim 1, wherein the third step further includes a step of reconnecting, when a superior network condition and service for the user exist while the user is connected to the network connection device and the service providing device, the user to a network connection device and a service providing device corresponding to the superior network condition and service.

7. The authentication matching method as claimed in claim 6, wherein the third step further includes a step of notifying, when a superior network condition and service for the user exist while the user is connected to the network connection device and the service providing device, the superior network condition and service to the user, and of reconnecting, when the user desires to be reconnected to the superior network condition and service, the user to the network connection device and the service providing device respectively corresponding thereto.

8. An authentication matching device comprising:
a first means authenticating access from a user;
a second means selecting, when the access is authenticated at the first means, an optimum network condition and an optimum service from a database depending on a condition which the user desires to use; and
a third means connecting the user to a network connection device and a service providing device respectively corresponding to the network condition and the service selected at the second means.

9. The authentication matching device as claimed in claim 8, wherein the second means includes a means selecting and presenting a plurality of candidates for the optimum network condition and the optimum service to the user, thereby enabling a selection based on a user's intension.

10. The authentication matching device as claimed in claim 8, wherein the second means includes a means adding a condition of the user set by the service providing device upon the selection of the network condition and the service.

11. The authentication matching device as claimed in claim 10, wherein the second means includes a means refusing a service provision upon having determined that the selected network condition and service are not matched with the user's condition set by the service providing device.

12. The authentication matching device as claimed in claim 8, wherein the third means further includes a means reselecting an optimum network condition and service, when the user becomes unable to use the network connection device due to a change of the network condition while the user is connected to the network connection device and the service providing device.

13. The authentication matching device as claimed in claim 8, wherein the third means further includes a means reconnecting, when a superior network condition and service for the user exist while the user is connected to the network connection device and the service providing device, the user to a network connection device and a service providing device corresponding to the superior network condition and service.

14. The authentication matching device as claimed in claim 13, wherein the third means further includes a means notifying, when a superior network condition and service for the user exist while the user is connected to the network connection device and the service providing device, the superior network condition and service to the user, and reconnecting, when the user desires to be reconnected to the superior network condition and service, the user to the network connection device and the service providing device respectively corresponding thereto.
